(19) United States
(12) Patent Application Publication
(10) Pub. No.: US 2005/0214602 A1
(43) Pub. Date: Sep. 29, 2005

(54) Load following algorithm for a fuel cell based distributed generation system

(76) Inventors: Manish Sinha, Pittsford, NY (US); Matthew C. Kirklin, Rochester, NY (US); Clark G. Hochgraf, Rochester, NY (US)

Correspondence Address: CARY W. BROOKS;General Motors Corporation, Mail Code 482-C23-B21, P.O. Box 300, Detroit, MI, 48265-3000, US

(21) Appl. No.: 10/811,161

(22) Filed: Mar. 26, 2004

(51) Int. Cl. H01M 8/04; H01M 16/00

(52) U.S. Cl. 429/22; 429/23; 429/9; 429/13

(57) ABSTRACT

A fuel cell distributed generation system that employs a load following control algorithm that provides the desired output power from a fuel cell on demand. The system includes a current sensor that measures the current drawn from the fuel cell available to satisfy the application load demands. A fuel cell controller receives the measured current and provides a command signal to the fuel cell to increase or decrease its power generation based on the demand. The controller also defines a maximum current that the system can draw from the fuel cell based on its fuel input. The system may include a battery current sensor that measures battery current to insure that the system battery is not being drained. Also, the system may include a battery voltage sensor that monitors battery voltage drift.

### BACKGROUND OF THE INVENTION

1. Field of the Invention

This invention relates generally to a fuel cell based distributed generation system employing a load following algorithm and, more particularly, to a fuel cell based distribution generation system that employs a load following algorithm, where the system includes a current sensor for measuring the output current drawn from the fuel cell, a current sensor for measuring the output current provided by the system battery and a voltage sensor for measuring the output voltage of the battery so as to control the output power of the fuel cell in response to power demands from the loads of the system.

2. Discussion of the Related Art

Hydrogen is a very attractive fuel because it is clean and can be used to efficiently produce electricity in a fuel cell. The automotive industry expends significant resources in the development of hydrogen fuel cells as a source of power for vehicles. Such vehicles would be more efficient and generate fewer emissions than today's vehicles employing internal combustion engines.

A hydrogen fuel cell is an electrochemical device that includes an anode and a cathode with an electrolyte therebetween. The anode receives hydrogen gas as a fuel and the cathode receives oxygen or air. The hydrogen gas is disassociated in the anode to generate free hydrogen protons and electrons. The hydrogen protons pass through the electrolyte to the cathode where they react with the oxygen and the electrons in the cathode to generate water. The electrons disassociated in the anode cannot pass through the electrolyte, and thus are directed through a load to perform work before being sent to the cathode.

Proton exchange membrane fuel cells (PEMFC) are a known popular fuel cell. The PEMFC generally includes a solid polymer electrolyte proton conducting membrane, such as a perfluorisulfonic acid membrane. The anode and the cathode typically include finely divided catalytic particles, usually platinum (Pt), supported on carbon particles and mixed with an ionomer. The combination of the anode, cathode and membrane define a membrane electrode assembly (MEA). MEAs are relatively expensive to manufacture and require certain conditions for effective operation. These conditions include proper water management and humidification, and control of catalyst poisoning constituents, such as carbon monoxide (CO).

Typically, a system employing a fuel cell for generating power includes a fuel cell distributed generation (FCDG) system that provides a conditioned alternating current (AC) to provide the desired power requirements for a particular application. The FCDG system provides the amount of power based on the demand from the system loads at a particular point in time. For an automotive application, the vehicle operator presses the power pedal to generate more vehicle speed, which requires more output power from the fuel cell. The power request is made to the power train of the vehicle. The additional power to increase the vehicle speed is not provided to the power train until it is being produced and is available from the fuel cell. Thus, it takes a certain amount of time from the time that the operator presses the power pedal until the desired amount of power is provided by the fuel cell. Sometimes this time period is on the order of 10 seconds.

In other applications, such as home power generation applications, the FCDG system will draw all the power it needs immediately from the fuel cell, possibly drawing more power than the fuel cell is able to provide from its current fuel input. For example, a user may flip a switch to start an appliance where the added power demand is necessary instantaneously. When this happens, the power draw from the fuel cell could damage the fuel cell by attempting to draw more current than the fuel cell is capable of delivering at that moment in time. Thus, known FCDG systems employ an additional power source, such as a battery, in parallel with the fuel cell to meet the additional power requirements during the transient time between when the power request is made and the fuel cell begins generating the additional power.

An FCDG system can employ a load following algorithm that conditions and provides the desired amount of output power virtually instantaneously and absolutely to satisfy the loads as they are connected and disconnected to and from the FCDG system. To do this, the load following algorithm manages the dual power sources of the battery and the fuel cell to reject and control the disturbances imposed on the fuel cell by the changing loads.

FIG. 1 is a general schematic block diagram of an FCDG system 10. The system 10 includes a fuel cell 12 that generates output power based on the principles discussed above. The system 10 also includes a storage battery 14 that provides additional power at those times that the fuel cell 12 is not providing enough power to operate certain distributed generation (DG) loads 24. The system 10 also includes a power conditioning module 18 that includes DC/DC converters and DC/AC inverters for converting the DC power from the fuel cell 12 to DC power of various voltage levels and the DC power from the fuel cell 12 to AC power for the loads 24.

The fuel cell 12 provides variable voltage DC power on output line 16 to the power conditioning module 18 depending on the fuel input to the fuel cell 12. Likewise, the battery 14 provides DC power on line 20 to the power conditioning module 18, such as for example, 60 volts DC power. The power conditioning module 18 includes the appropriate circuitry to condition the DC power to different DC power levels and to AC power. The AC power is provided on line 22 to operate the various DG loads 24 depending on the particular application. The DG loads 24 can be switched on and off at any time to draw less or more power from the fuel cell 12.

The power conditioning module 18 provides conditioned DC power on line 26 for certain devices in the fuel cell 12, such as 380 volts for a system compressor that provides the anode input air. The power conditioning module 18 also provides conditioned DC power on line 28 to the fuel cell 12 at a lower voltage level than the line 26, such as 12 and/or 40 volts, to operate other fuel cell components, such as low power ancillary components. The power conditioning module 18 also provides DC power on line 30 to charge the battery 14 during those times that the fuel cell 12 is providing more power than is required by the DG loads 24.

Certain constraints are imposed on the control system operating the system 10. Particularly, current drawn from the fuel cell 12 (I_fuelcell) should not exceed the current available from the fuel cell stack (I_maxFC). Further, the rate of change of the flow of current from the fuel cell 12 is limited as a result of flow dynamics. Testing, durability concerns and components collectively define the flow dynamics. For this disclosure, the flow dynamic is limited to:

$$\frac{ⅆ ( I\_fuelcell )}{ⅆ t} \leq 25 ( amps \text{/} s ) \qquad ( 1 )$$

Additionally, the battery output voltage should be maintained between 62 V and 70 V. Battery current during charging has to be limited to avoid battery boil off, i.e., I_batt≧−10 amps. Also, the fuel cell voltage has to be maintained within a certain percentage of its polarization curve. The fuel cell diagnostics would shut the system down if these parameters are violated to protect the fuel cell from irreversible damage.

As discussed above, FCDG systems can employ load following or load balancing algorithms to power balance the primary load, the compressor load and the low power ancillary loads with the power generator by the fuel cell 12. If the power on the lines 16, 20, 22, 26, 28 and 30 can be accurately measured by suitable sensors and the efficiency of the power conditioning module 18 is accurately known, then the power balance can be expressed as:

$$η = \frac{{P}_{cmp} + {P}_{anc} + {P}_{load}}{{P}_{fuelcell} + {P}_{batt}} \qquad ( 2 )$$

In equation (2), P_{cmp} is the compressor power on the line 26, P_{anc} is the ancillary power on the line 28, P_{load} is the AC load on the line 22, P_{fuelcell} is the power provided by the fuel cell 12 on the line 16, P_{batt} is the power on the line 20 from the battery 14, and η is the overall efficiency of the power conditioning module 18.

Thus, if the efficiency η is known and all the power is measured in the FCDG system by current and voltage sensors, then P_{fuelcell} can be calculated. However, if any of the power measurements are underestimated, the power requirement can cause the battery 14 to be drained over a period of time. On the other hand, if the sensors over-estimate the power measurements, the system 10 will operate inefficiently. In addition to being able to accurately measure the currents discussed herein, such a scheme would require at least ten voltage and current sensors, and a fully developed efficiency map over the entire operating range of the system 10. Thus, such a technique may not be very fault tolerant.

### SUMMARY OF THE INVENTION

In accordance with the teachings of the present invention, a fuel cell distributed generation (FCDG) system is disclosed that employs a load following algorithm that provides the desired output power of the fuel cell on demand. The system includes a draw current sensor that measures the current drawn from the fuel cell used to satisfy the system load demands. A fuel cell controller uses the measured draw current and provides a command signal to the fuel cell to increase or decrease its power generation based on the demand. The controller also defines a maximum draw current that the system can draw from the fuel cell based on its fuel input. The load following algorithm determines an approach threshold region and a diverge threshold region that define when the fuel cell should increase or decrease power generation based on the changing power requirements.

The system may include a battery current sensor that measures battery current to insure that the system battery is not being drained. Also, the system may include a battery voltage sensor that monitors battery voltage drift over time.

Additional advantages and features of the present invention will become apparent from the following description and appended claims, taken in conjunction with the accompanying drawings.

### BRIEF DESCRIPTION OF THE DRAWINGS

FIG. 1 is a representative schematic block diagram of a fuel cell based distributed generation system;

FIG. 2 is a fuel cell based distributed generation system employing a load following algorithm, according to an embodiment of the present invention;

FIG. 3 is a graph with time on the horizontal axis and current on the vertical axis showing a graphical representation of the load following loop control for the system shown in FIG. 2; and

FIG. 4 is a graph with time on the horizontal axis and current on the vertical axis showing the lag between the required current from the fuel cell and the available current from the fuel cell.

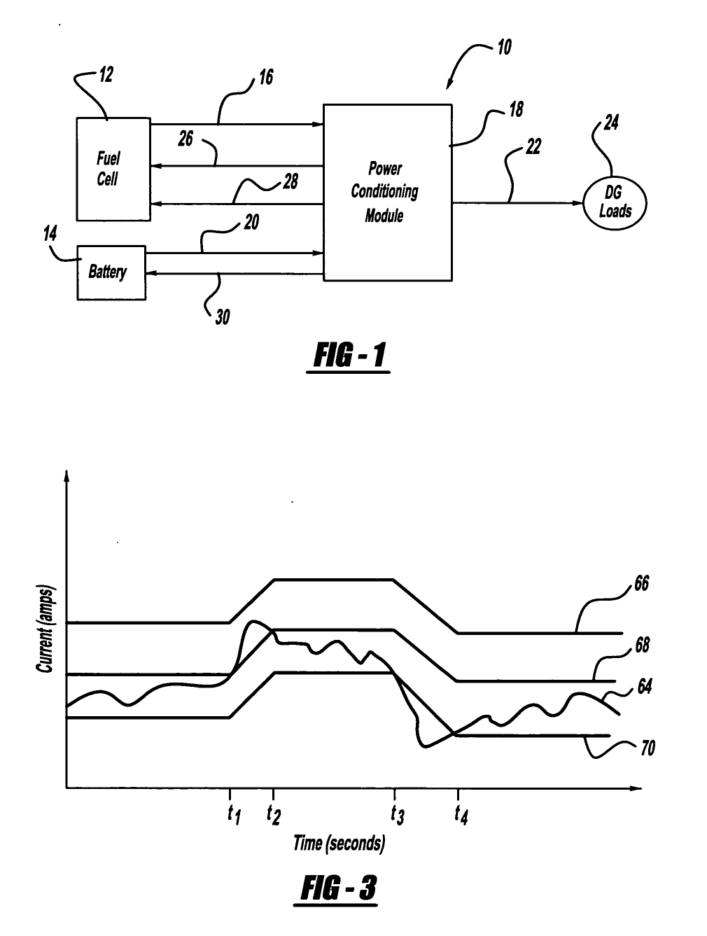

### DETAILED DESCRIPTION OF THE EMBODIMENTS

The following discussion of the embodiments of the invention directed to a fuel cell based distributed generation system employing a load following algorithm is merely exemplary in nature, and is in no way intended to limit the invention or its applications or uses.

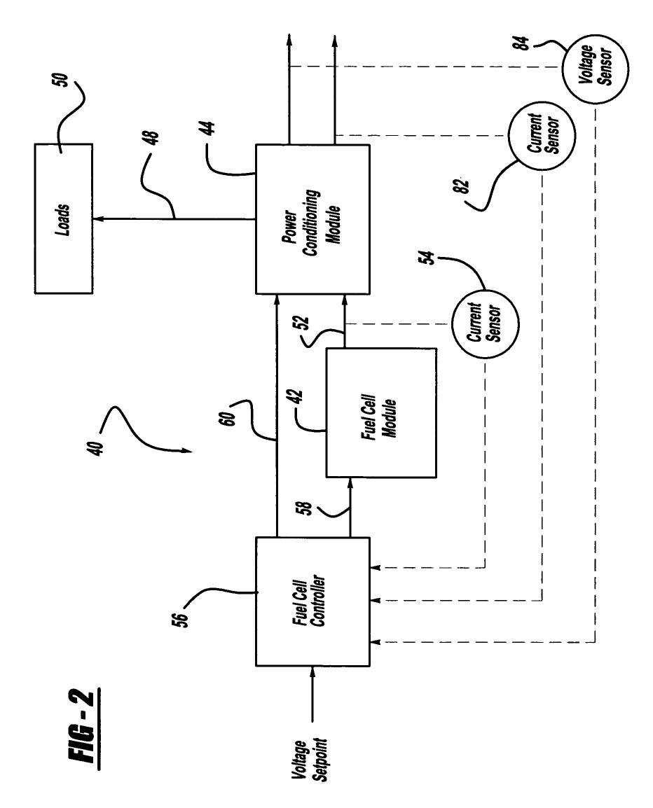

FIG. 2 is a schematic block diagram of an FCDG system 40, according to an embodiment of the present invention. The FCDG system 40 includes a fuel cell module 42 having a fuel cell stack for providing output current to drive a particular load. The system 40 also includes a power conditioning module 44 similar to the power conditioning module 18 that includes DC/DC converters and DC/AC inverters. In this design, a system battery is included in the power conditioning module 44 that provides the additional power that the system 40 may be required to deliver before the fuel cell module 42 has had an opportunity to ramp up during increased power demands.

The power conditioning module 44 provides AC power on an output line 48 applied to various AC loads 50 that the system 40 is driving. In one embodiment, the system 40 is employed in a vehicle for providing power to drive the vehicle. However, as will be appreciated by those skilled in the art, the system 40 can be employed in any suitable full cell system, such as a home or business power generation system.

According to the invention, the system 40 includes a current draw sensor 54 that measures the draw current I_fuelcell from the fuel cell module 42 on line 52 being drawn by the power conditioning module 44 to satisfy the demands of the loads 50. The current sensor 54 provides a signal to a fuel cell controller 56 indicative of the measured draw current I_fuelcell. The fuel cell controller 56 determines the maximum draw current I_maxFC available to be drawn from the fuel cell module 42. The controller 56 also provides a command I_reqFC to the fuel cell module 42 on line 58 that instructs the fuel cell module 42 to generate a certain amount of power based on a load following algorithm discussed below. In other words, the command I_reqFC determines the amount of fuel and air that should be provided to the fuel cell module 42 based on the current power demands of the loads 50.

The current controller 56 also provides a current draw signal I_draw to the power conditioning module 44 on line 60, where the controller 56 sets the current draw signal I_draw to the maximum draw current I_maxFC. Thus, the power conditioning module 44 knows to only draw as much current from the fuel cell module 42 as the fuel cell module 42 is currently able to produce, and knows to take any further power demanded by the loads 50 from the battery.

FIG. 3 shows a graphical representation of how the load following algorithm controls the amount of fuel provided to the fuel cell module 42 based on the current power demands, according to the invention. FIG. 3 is a graph with time on the horizontal axis and current on the vertical axis depicting the operation of the load following algorithm. Graph line 64 represents the draw current I_fuelcell being drawn by the power conditioning module 44 to satisfy the loads 50 at any particular point in time. Graph line 66 represents the maximum current I_maxFC available from the fuel cell module 42 at the current fuel input.

Graph line 68 defines an approach threshold (AT) region between the graph line 66 and the graph line 68. If the power drawn by the power conditioning module 44, the graph line 64, enters the approach threshold region between the graph lines 64 and 66, as indicated at time t₁, then the power conditioning module 44 is using most of the available current from the fuel cell module 42 to satisfy the system demands. When this happens, the fuel cell controller 56 increases the available power output of the fuel cell module 42 by causing an increase in the fuel applied to the fuel cell module 42 through the command I_reqFC. This causes the maximum draw current I_maxFC available from the fuel cell module 42 to ramp up. The approach threshold region is maintained constant, so that as the maximum draw current I_maxFC increases, the AT graph line 68 increases. When the draw current I_fuelcell drops below the AT graph line 68, and thus out of the approach threshold region, the fuel provided to the fuel cell module 12 is held steady by the command I_reqFC, as indicated at time t₂.

Graph line 70 defines a diverge threshold (DT) region below the graph line 68. If the draw current I_fuelcell drops below the graph line 68, as indicated at time t₃, then the power conditioning module 44 is not using enough of the available current from the fuel cell module 42. When this happens, the controller 56 reduces the fuel input to the fuel cell module 42 by the command I_reqFC so that the maximum draw current I_maxFC ramps downward. When the draw current I_fuelcell returns to the operation region between the AT graph line 68 and the DT graph line 70, the controller 56 holds the fuel applied to the fuel cell module 42 steady, as indicated at time t₄. Therefore, the command I_reqFC attempts to keep the draw current I_fuelcell between the AT graph line 68 and the DT graph line 70.

The AT and DT regions effect how the fuel cell module 42 is operated with respect to the draw current I_fuelcell. If the current being drawn is much less than the maximum draw current I_maxFC, then hydrogen utilization is low. However, if the draw current I_fuelcell is close to the maximum draw current I_maxFC it is possible due to measurement error, the current is actually greater than the maximum draw current I_maxFC and can damage the fuel cell module 42. A ramp rate (RR) defines the rate of increase or decrease of the command I_reqFC, and is tuned by the dynamic capability of the fuel cell module 42.

The load following algorithm operated by the current controller 56 is based on the maximum draw current I_maxFC. Due to the dynamics of the fuel cell module 42, the current I_maxFC lags the command I_reqFC. In other words, there is a certain time between when the fuel is applied to the fuel cell module 42, and when the additional fuel cell power is actually available from the fuel cell module 42. This lag is primarily due to the time it takes the compressor to spool up to the desired air generation.

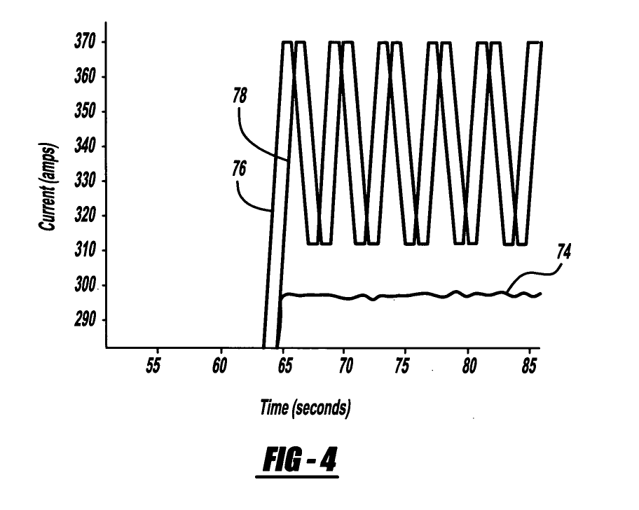

FIG. 4 illustrates this lag where time is on the horizontal axis and current is on the vertical axis. Graph line 74 shows the draw current I_fuelcell being drawn by the power conditioning module 44 based on the requirements of the loads 50. Graph line 76 is the command I_reqFC and graph line 78 is the maximum draw current I_maxFC showing the lag mentioned above. As is known in control theory, a lag is a common source of instability in a system and manifests itself as sustained oscillations of the controlled signal. FIG. 4 shows such an unstable oscillatory control if the I_maxFC is used. To address this phase lag, the load following algorithm of the invention compares the draw current I_fuelcell with the command I_reqFC and not the maximum draw current I_maxFC. The assumption is that the command I_reqFC is an effective controller output and the maximum draw current I_maxFC will follow the command I_reqFC after the dynamic delay. A diagnostic algorithm can be developed for the controller 56 to monitor whether the maximum draw current I_maxFC is following the command I_reqFC, and if not shut the system 40 down.

As discussed above, a control loop ensures that the draw current I_fuelcell is maintained below the maximum draw current I_maxFC. However, if the sensor 54 has significant noise, the maximum draw current I_maxFC may be less than the draw current I_fuelcell. In this situation the battery current is used to satisfy the load demands. However, if this situation is not detected and the output of the fuel cell module 42 is not increased, the battery may be eventually drained. According to the invention, this situation is prevented by providing a battery current sensor 82 that senses the battery current I_batt, and provides a signal indicative of the battery current I_batt to the fuel cell controller 56. If the battery current I_batt is persistently positive based on predetermined parameters, battery power is being continually used, and the algorithm is not preventing the draw current I_fuelcell to be below the maximum draw current I_maxFC. If this occurs, the command I_reqFC is ramped up to ensure that the battery is not drained.

Further, the battery voltage may drift over time. In order to accommodate drifts in the battery voltage, the system 40 includes a voltage sensor 84 to measure the voltage of the battery. The sensed battery voltage is applied to the fuel cell controller 56 to control the current draw signal I_draw. The controller 56 compares the measured battery voltage to a voltage set point to determine the voltage drift. The measured battery voltage keeps the charge current of the battery below a predetermined value, such as 10 amps. The controller 56 can provide an increase in the command I_reqFC to charge the battery. However, the increase is limited so that the charge current does not exceed 10 amps.

As discussed above, this invention addressed the following unmeasured load as seen in the distributed generation systems. However, the approach developed by this invention can also be used to follow unmeasured loads in a vehicle, such as air-conditioning or other accessories.

The foregoing discussion discloses and describes merely exemplary embodiments of the present invention. One skilled in the art will readily recognize from such discussion and from the accompanying drawings and claims, that various changes, modifications and variations can be made therein without departing from the spirit and scope of the invention as defined in the following claims.

1. A fuel cell distribution system for controlling power being applied to a system load, said system comprising:
a fuel cell, said fuel cell generating a draw current;
a power conditioning module responsive to the draw current, said power conditioning module conditioning the draw current and applying the conditioned draw current to the system load;
a fuel cell sensor, said fuel cell sensor measuring the draw current from the fuel cell and generating a fuel cell signal indicative of the measured draw current; and
a fuel cell controller responsive to the fuel cell signal, said fuel cell controller operating a load following algorithm that defines a command signal applied to the fuel cell that sets the available output power from the fuel cell, said load following algorithm also defining a maximum current draw signal applied to the power conditioning module that defines a maximum draw current to be drawn from the fuel cell.

2. The system according to claim 1 wherein the load following algorithm defines an approach threshold region, and wherein the fuel cell controller increases the available output power by the command signal if the draw current enters the approach threshold region.

3. The system according to claim 2 wherein the load following algorithm maintains the available output power constant by the command signal if the draw current leaves the approach threshold region.

4. The system according to claim 1 wherein the load following algorithm defines a diverge threshold region, and wherein the fuel cell controller decreases the available output power by the command signal if the draw current enters the diverge threshold region.

5. The system according to claim 4 wherein the load following algorithm maintains the available output power constant by the command signal if the draw current leaves the diverge threshold region.

6. The system according to claim 1 further comprising a battery and a battery current sensor, said battery providing battery current for the system load and said battery current sensor measuring the battery current, said battery current sensor generating a battery current signal indicative of the measured battery current.

7. The system according to claim 6 wherein the fuel cell controller is responsive to the battery current signal, said fuel cell controller increasing the available output power if the battery sensor measures a predetermined battery current continuously for a predetermined period of time.

8. The system according to claim 1 further comprising a battery and a battery voltage sensor, said battery providing battery voltage for the system load and said battery voltage sensor measuring the battery voltage, said battery voltage sensor generating a battery voltage signal indicative of the measured battery voltage.

9. The system according to claim 8 wherein the fuel cell controller is responsive to the battery voltage signal, said fuel cell controller monitoring battery voltage drift and determining a charge current applied to the battery by increasing the power generated by the fuel cell.

10. The system according to claim 1 wherein the system provides power to a vehicle.

11. The system according to claim 1 wherein the system is part of a vehicle control system that follows unmeasured loads in a vehicle.

12. The system according to claim 11 wherein the unmeasured loads are from a vehicle heating ventilation and air conditioning system.

13. A fuel cell distribution system for controlling power being applied to a system load, said system comprising:
a fuel cell, said-fuel cell generating a draw current;
a battery, said battery generating a battery current;
a power conditioning module responsive to the draw current and the battery current, said power conditioning module conditioning the draw current and the battery current and applying the conditioned draw current and battery current to the system load;
a fuel cell sensor, said fuel cell sensor measuring the draw current from the fuel cell and generating a fuel cell signal indicative of the measured draw current; and
a fuel cell controller responsive to the fuel cell signal, said fuel cell controller operating a load following algorithm that defines a command signal applied to the fuel cell that sets the available output power from the fuel cell, said load following algorithm also defining a maximum draw current signal applied to the power conditioning module that defines a maximum draw current to be drawn from the fuel cell, said load following algorithm defining an approach threshold region, wherein the fuel cell controller increases the available output power by the command signal if the draw current enters the approach threshold region, and wherein the load following algorithm maintains the available output power constant by the command signal if the draw current leaves the approach threshold region, said load following algorithm also defining a diverge threshold region, wherein the fuel cell controller decreases the available output power by the command signal if the draw current enters the diverge threshold region, and wherein the load following algorithm maintains the available output power constant by the command signal if the draw current leaves the diverge threshold region.

14. The system according to claim 13 further comprising a battery current sensor, said battery current sensor measuring the battery current, said battery current sensor generating a battery current signal indicative of the measured battery current, wherein the fuel cell controller is responsive to the battery current signal, said fuel cell controller increasing the available output power if the battery sensor measures a predetermined battery current continuously for a predetermined period of time.

15. The system according to claim 13 further comprising a battery voltage sensor, said battery voltage sensor measuring the battery voltage, said battery voltage sensor generating a battery voltage signal indicative of the measured battery voltage, wherein the fuel cell controller is responsive to the battery voltage signal, said fuel cell controller monitoring battery voltage drift and controlling a charge current applied to the battery.

16. A method for distributing power from a fuel cell to a load, said method comprising:
drawing current from the fuel cell to a power conditioning module;
conditioning the draw current in the power conditioning module;
applying the conditioned draw current to the system load;
measuring the draw current from the fuel cell;
defining a command signal applied to the fuel cell that sets the available output power from the fuel cell; and
defining a maximum draw current signal applied to the power conditioning module that defines the maximum draw current to be drawn from the fuel cell.

17. The method according to claim 16 wherein defining a command signal includes defining an approach threshold region, and increasing the available output power by the command signal if the draw current enters the approach threshold region.

18. The method according to claim 17 wherein defining a command signal includes maintaining the available output power constant by the command signal if the draw current leaves the approach threshold region.

19. The method according to claim 16 wherein defining a command signal includes defining a diverge threshold region below, and decreasing the available output power by the command signal if the draw current enters the diverge threshold region.

20. The method according to claim 19 wherein defining a command signal includes maintaining the available output power constant by the command signal if the draw current leaves the diverge threshold region.

21. The method according to claim 16 further comprising measuring battery current from a battery, and increasing the available output power if the measured battery current is continuously above a predetermined amount for a predetermined period of time.

22. The method according to claim 16 further comprising measuring battery voltage from a battery, and monitoring battery voltage drift from the battery voltage.
